(19) United States
(12) Patent Application Publication
(10) Pub. No.: US 2009/0325758 A1
(43) Pub. Date: Dec. 31, 2009

(54) Hydrau-Linear Automatic Bicycle Transmission

(76) Inventor: Bruce Ferguson, Baltimore, MD (US)

Correspondence Address: Hanify & King Professional Corporation, 1055 Thomas Jefferson Street, NW, Suite 400, WASHINGTON, DC, 20007, US

(21) Appl. No.: 12/477,074

(22) Filed: Jun. 2, 2009

Related U.S. Application Data
(60) Provisional application No. 61/131,361, filed on Jun. 9, 2008.

(51) Int. Cl. F16H 61/38

(52) U.S. Cl. 477/68

(57) ABSTRACT

One aspect of the present invention includes a transmission that includes a cylindrical housing that includes a plurality of parts. The internal parts rotate in unison with the drive shaft, and the centrifugal force created by the rotation of the cone shaped impeller pushes the fluid throughout the transmission. The fluid pressure is used to change the gear ratio from low gear to high gear, and vice versa.

### CROSS-REFERENCE TO RELATED APPLICATIONS

The present application claims priority to U.S. Provisional Application No. 61/131,361, filed Jun. 9, 2008, entitled Hydrau-Linear Automatic Bicycle Transmission, the entirety of which is incorporated herein by reference.

### FIELD OF THE INVENTION

The present application relates to an automatic transmission for wheeled vehicles. More specifically, the present application relates to hydrau-linear automatic bicycle transmission.

### BACKGROUND OF THE INVENTION

Wheeled vehicles typically use a transmission based on a series of gears and/or sprockets in order to make their operation more efficient. A transmission can range from manually shifted to fully automatic. Transmissions are used in vehicles as diverse as bicycles, cars, motorcycles, and off road vehicles. The goal of a typical transmission is to generate torque on the wheels of a vehicle based on the motion of a drive shaft.

Automatic transmissions require little manual intervention, and automatically select gears based on a variety of factors, such as a torque converter or hydraulic pressure. Current transmissions for wheeled vehicles, however, lack efficiency and simplicity. A continuing need exists for an automatic transmission that is operable to simply and efficiently allow a user to operate a wheeled vehicle.

### SUMMARY OF THE INVENTION

One aspect of the present invention includes a mechanism that includes a plurality of moving parts that are initially controlled by the drive shaft and therefore, those parts rotate in unison with the drive shaft. A cylindrical housing is also included that houses the moving parts. Inside the mechanism, a fluid may be used to change the gear ratio from a low gear to a high gear. An impeller is among the moving parts, and serves to push fluid throughout the mechanism with the centrifugal force created by the rotation of the cone shaped impeller.

According to one embodiment, the drive shaft first engages a primary gear. The primary gear may be operatively connected with the series of gears with high and low speed of ratio. By rotating the drive shaft, the primary gear moves linearly along the series of gears. The gears preferably move a fully or partially encased impeller. The impeller pumps the fluid into the discharge chamber of the housing unit and the housing unit divides the fluid and sends it to two different places: the primary gear chamber and the suction intake chamber. The discharge chamber is preferably a separate unit but may be operatively connected to the impeller housing unit which is part of the second half of the pump housing.

The rotating disc is preferably positioned between the discharge chamber and the lowest or first gear. The outer edge of the rotating disc may be geared to the impellers so that it will rotate in unison with the rest of the mechanism, such as the drive shaft and the primary gear shaft. The rotating disc includes flow ports on the inner area of its face which distributes fluid to the suction area located inside the body of the series of gears. The disc also includes sliding vanes that function as gates into the primary gear chamber. The sliding vanes preferably rotate at the bottom of the discharge chamber and this rotation regulates the flow of the fluid into the primary gear chamber. With the movement of the rotating disc, proper pressure flow will be released into each chamber.

The suction intake chamber allows fluid to flow through into the suction intake of the impeller. Fluid flows into the suction chamber from two places; the discharge chamber through the rotating disc and the primary gear chamber through flow ports located at the area of the gears. The flow ports create a balance of pressure between the discharge chamber and the primary gear chamber and this balance of pressure ensures smooth internal operation of the mechanism.

The mechanism preferably utilizes an external bypass system. The bypass utilizes the excess pressure created by the impeller to operate a piston cylinder used to change the front sprocket gear ratio setting. The bypass includes two connections on the transmission connected together by tubing. The high pressure discharge flow port is connected with flow ports of the discharge chamber through an unrestricted area of the suction return chamber section. In addition, it is located next to the primary drive shaft and above the secondary bypass port. Both low pressure discharge port and the high pressure discharge port are located in each of their own parts of the ring manifold chamber of the housings end plate section. The low pressure suction return flow port may be located in the center of the end cap. In addition, it allows fluid to flow in and around the primary drive shaft and up into the suction area of the impeller.

In one embodiment, the end cap, utilizes two directional flow discs which distribute the fluid to the correct area of the mechanism. The outer directional flow disc is engaged by an internal piston, attached to by a connecting arm, and actuated by pressure from a solenoid actuated N.C. two way valve during high speed gear changing. The outer directional flow disc is used to block the flow into the suction area of the impeller. The inner directional flow disc is engaged in two ways. First, a spring clip will engage the disc during reverse operation of the primary drive shaft during low speed operations. And second, the bicycle handle bars switch creates pressure with a solenoid actuated two-way valve.

The switch during high speed gear changing operations activates two solenoid actuated two-way valves on the bypass and a solenoid actuated three way valves which pressurize and relieve the piston cylinder of the front bevel gear plate. The switch is will be of the double-pole and double-throw type for the two types of gear shifting which operates necessary functions of increasing and decreasing of the gear ratio of the transmission. The low pressure discharge bypass connected to the ring manifold of the end plate chamber section contains a check valve which runs parallel to the solenoid actuated two way valve of the high pressure discharge bypass which is connected to the high pressure discharge port. These two bypass lines tee together to utilize a single external bypass line.

The housing unit contains an internal suction return section located on the outside area of the embodiment. The entrance to the suction return ports may be located next to the discharge chambers exhaust port area. The area between the drive shaft and the entrance of the suction return ports contains a flow regulating valve. The flow regulating valve utilizes a cup ring, a resilient means, a pressure line and needle valve to regulate flow out of and pressure inside the primary gear chamber and into the internal and external suction returns or bypass systems.

The purge valve located in the top of the discharge chamber extending out through the side of the chambers' end plates on the housing unit, relieves air trapped in the top of the system. The fluid reservoir and check valve included in and utilized by the system are located at and tee into the suction return tubing between the three way valve and the suction port of the end cap. The R.P.M. sensors contained in the system are located on the front bevel gear plate and on the secondary drive shaft of the impeller. The sensor sends an electrical signal to a control or integrated circuit unit that triggers the solenoids to activate the valves to complete the automatic operations necessary.

### BRIEF DESCRIPTION OF THE DRAWINGS

Further features and advantages of the invention can be ascertained from the following detailed description that is provided in connection with the drawings described below:

FIG. 1 is a diagram that shows an exemplary hub section according to one aspect of the present invention;

FIG. 2 is a diagram showing one aspect of an internal drive shaft with bearings and a spring clip according to one embodiment of the present invention;

FIG. 3 is a diagram showing a side view of a series of gears according to one aspect of the present invention;

FIG. 4 is a diagram showing a front view of the series of gears shown in FIG. 3;

FIG. 5 is a diagram that shows a front and side view of an impeller according to one aspect of the present invention;

FIG. 6 is a diagram that shows a front and side view of a pump housing according to one aspect of the present invention;

FIG. 7 is a diagram that shows an exemplary discharge chamber plate section according to one aspect of the present invention;

FIG. 8 is a diagram showing an exemplary suction return chamber plate section according to one aspect of the present invention;

FIG. 9 is a diagram showing an exemplary end plate manifold section with a needle valve according to one aspect of the present invention;

FIG. 10 is a diagram showing an exemplary end cap with a manifold section according to one aspect of the present invention;

FIG. 11 is a diagram shown an exemplary manifold section with outer and inner directional flow discs;

FIG. 12 is a diagram showing an exemplary front and rear bevel gear plates with an external drive shaft;

FIG. 13 is a diagram showing a rear bevel gear plate according to one aspect of the present invention;

FIG. 14 is a diagram showing an exemplary embodiment of a front bevel gear plate according to one aspect of the present invention;

FIG. 15 is a diagram showing an exemplary embodiment of a front and side view of a rotating disk according to one aspect of the present invention;

FIG. 16 is a diagram showing an exemplary embodiment of a front and side view of a primary gear;

FIG. 17 is a diagram showing an exemplary embodiment of a plan view of a hydrau-linear propulsion system according to one aspect of the present invention;

FIG. 18 is a diagram showing an exemplary embodiment of the apparatus of the present invention; and

FIG. 19 is a diagram showing an exemplary embodiment of the apparatus of the present invention.

### DETAILED DESCRIPTION OF THE PREFERRED EMBODIMENTS

### The Exemplary Apparatus of the Present Invention

One aspect of the present invention relates to an automatic transmission for a wheeled vehicle. The automatic transmission described herein may be used in combination with a bicycle, tricycle, or the like. Other wheeled vehicles, such as scooters, may also be used in combination with the present invention. Those skilled in the art will understand that the present invention is not intended to be limited to any particular application.

It may be desirable for aspects of the present invention to be used in combination with propulsion generating systems, such as motors, engines, and the like. Other elements, such as electronics, processors, memory, and computer systems may also be used in combination with the present invention.

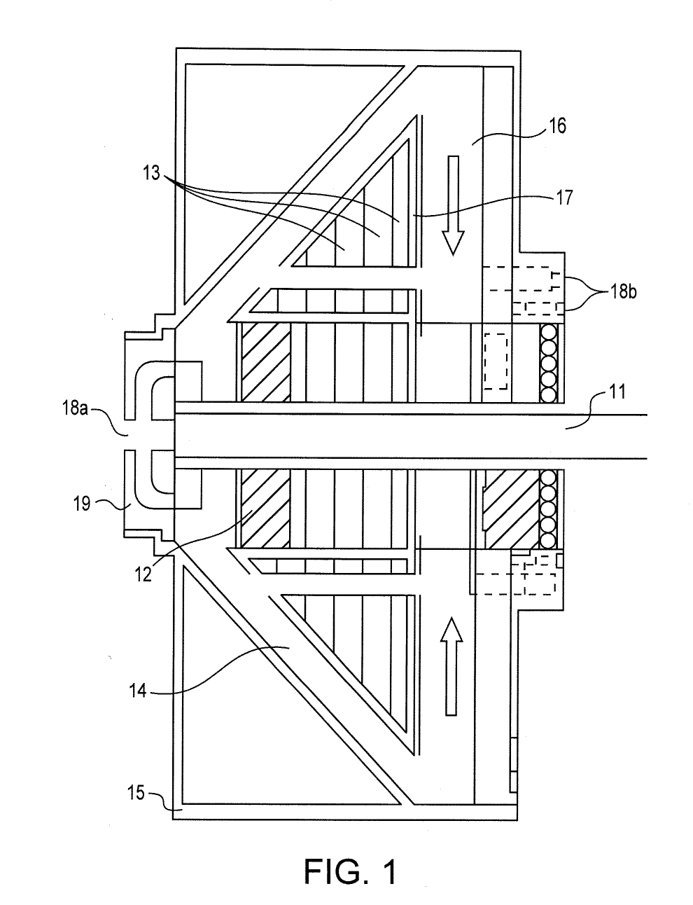

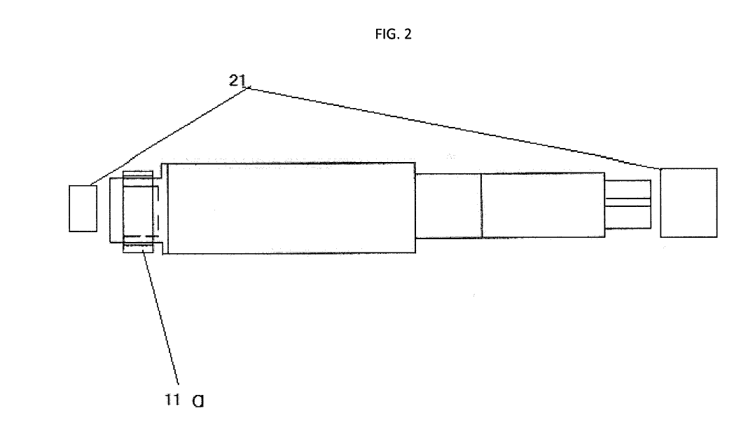

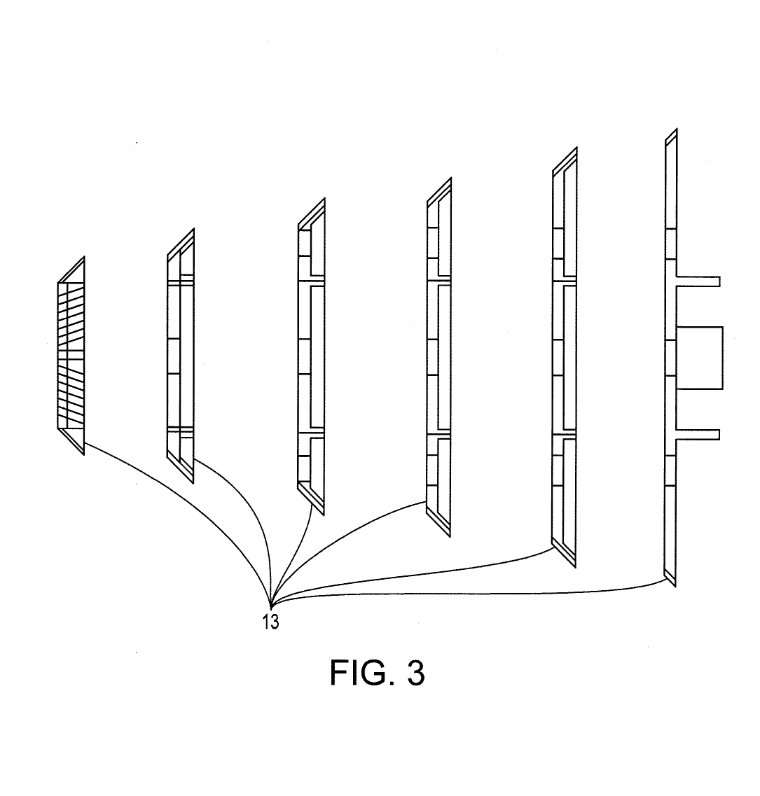

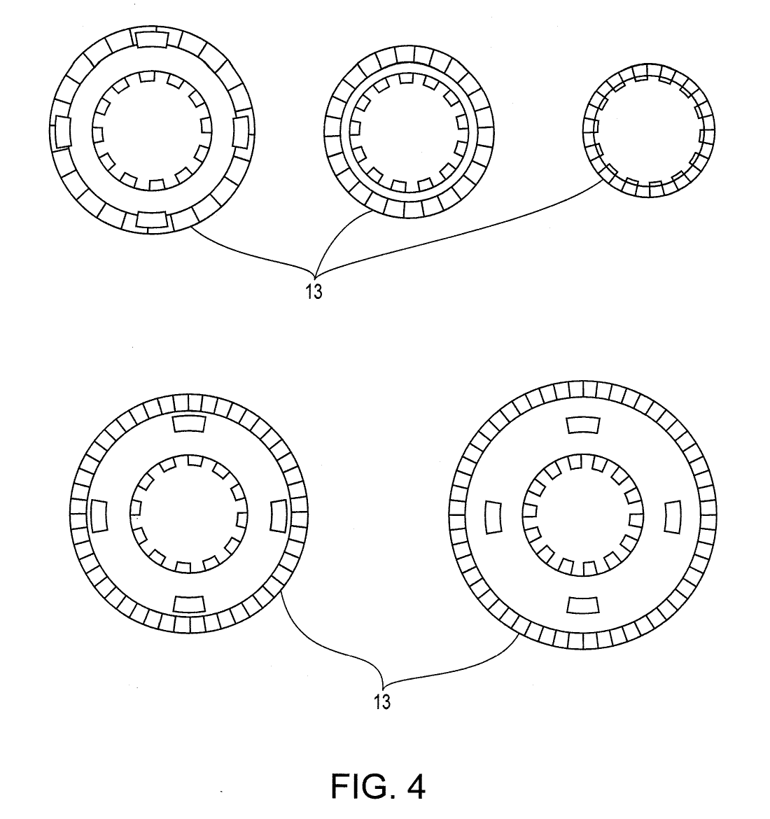

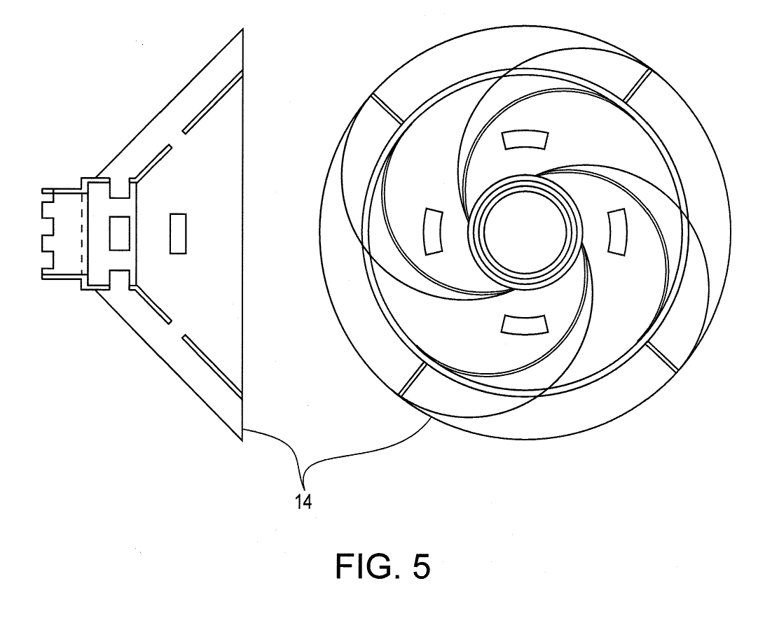

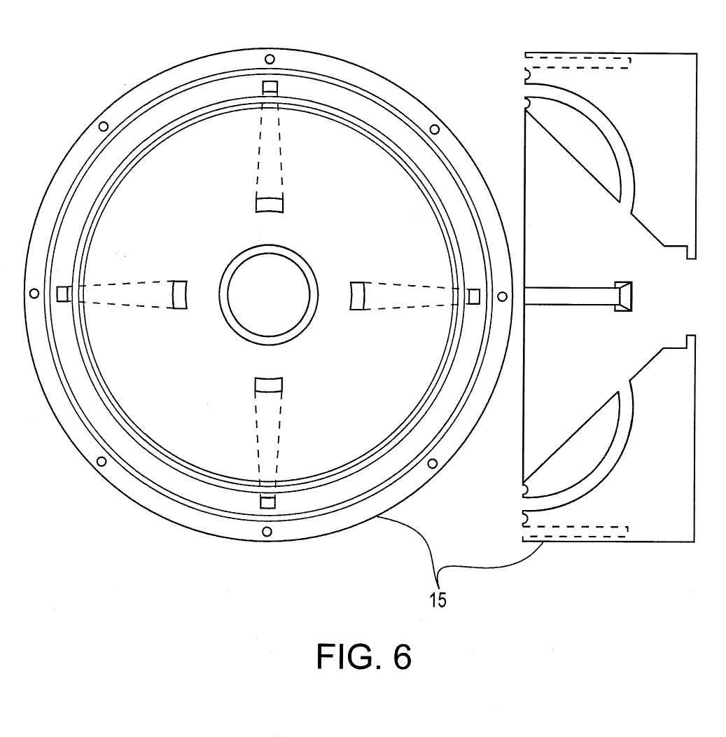

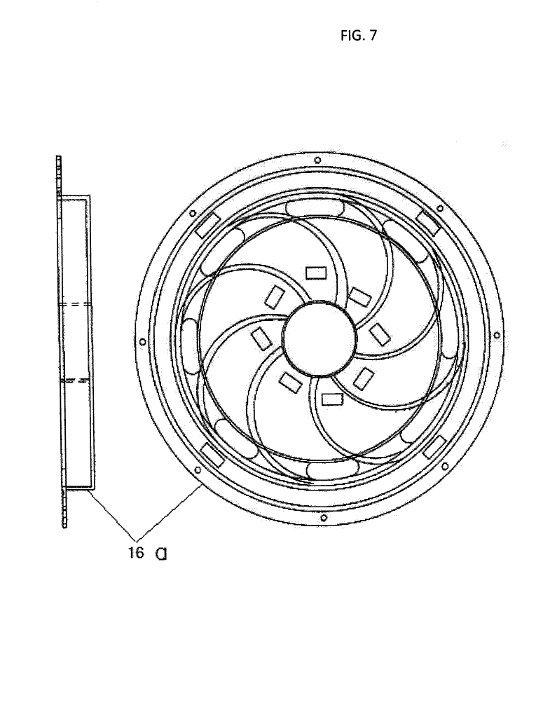

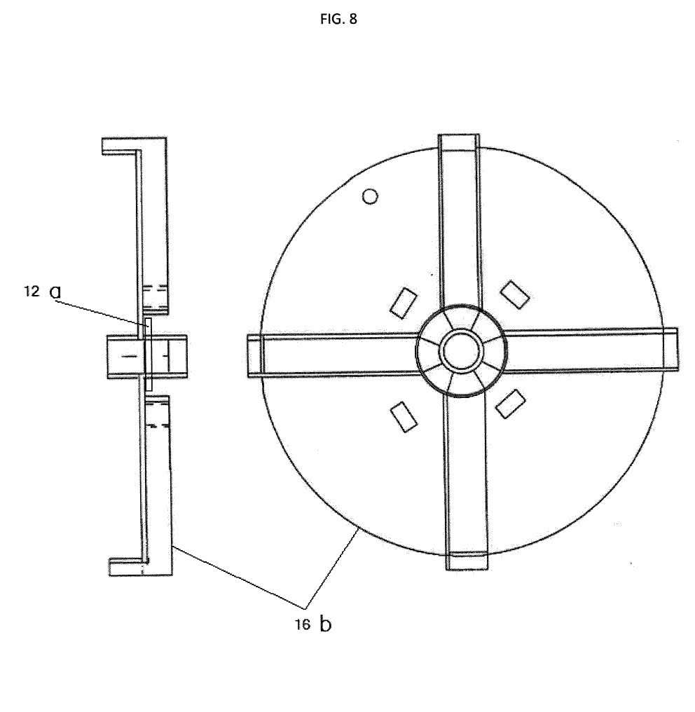

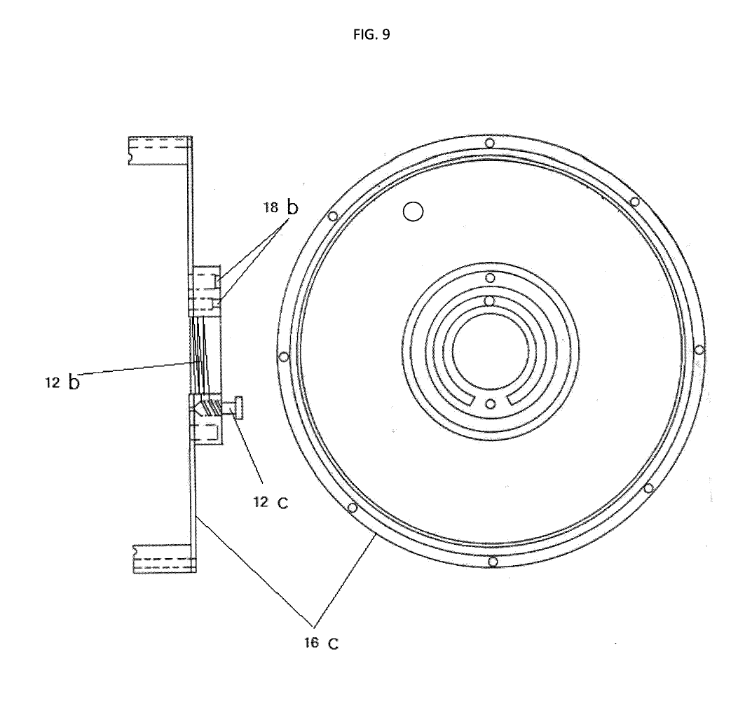

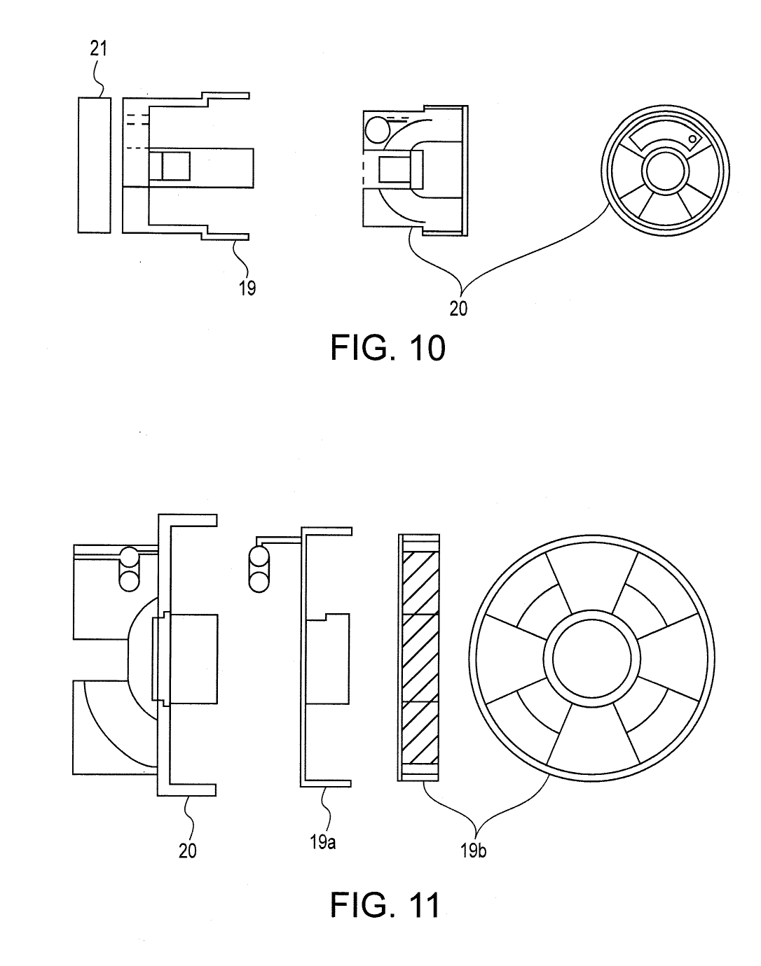

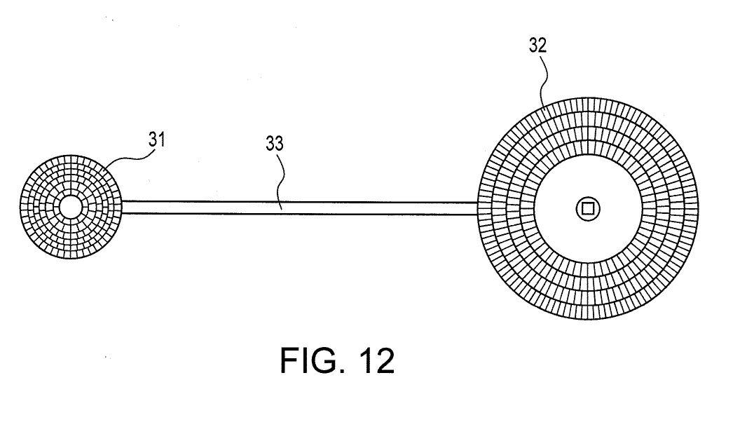

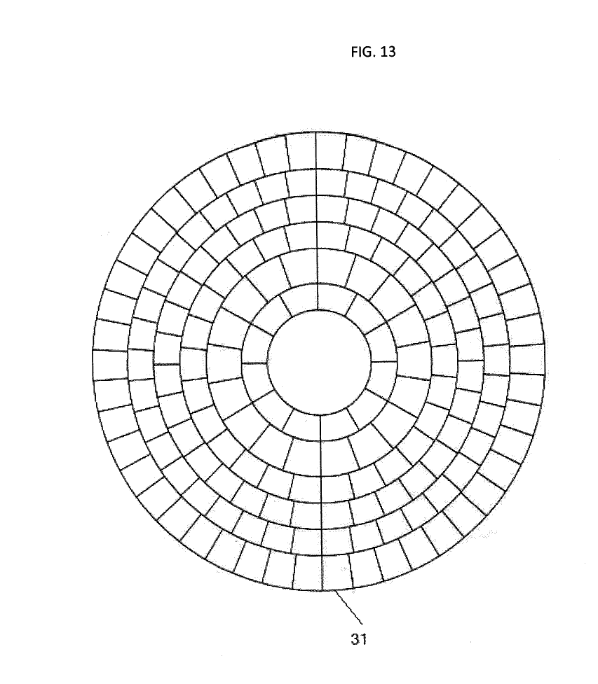

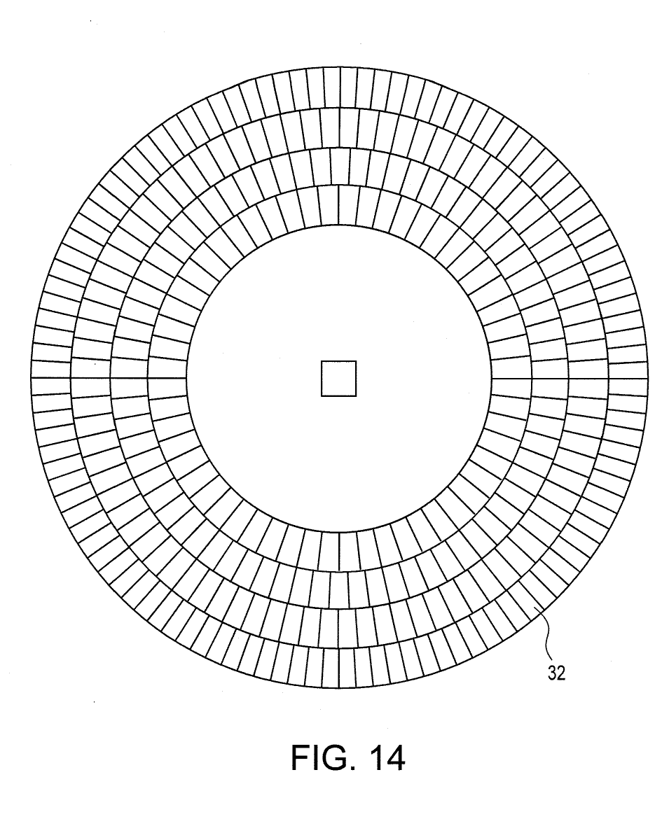

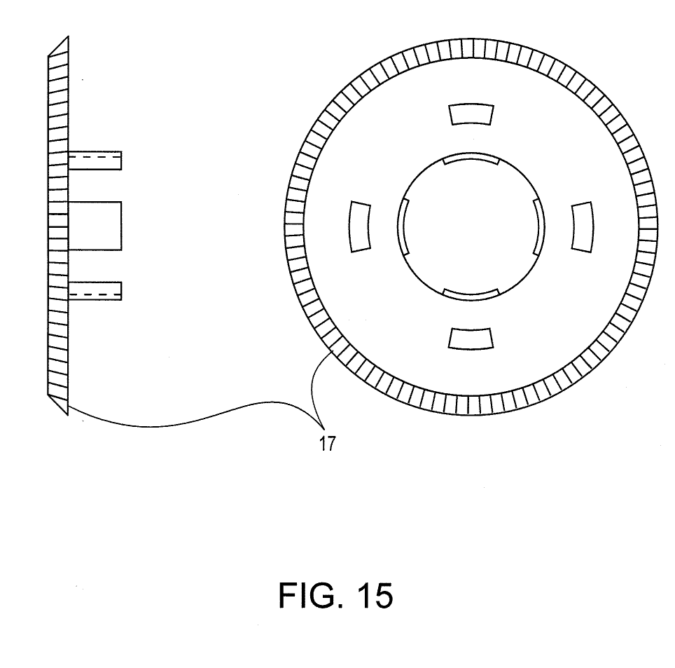

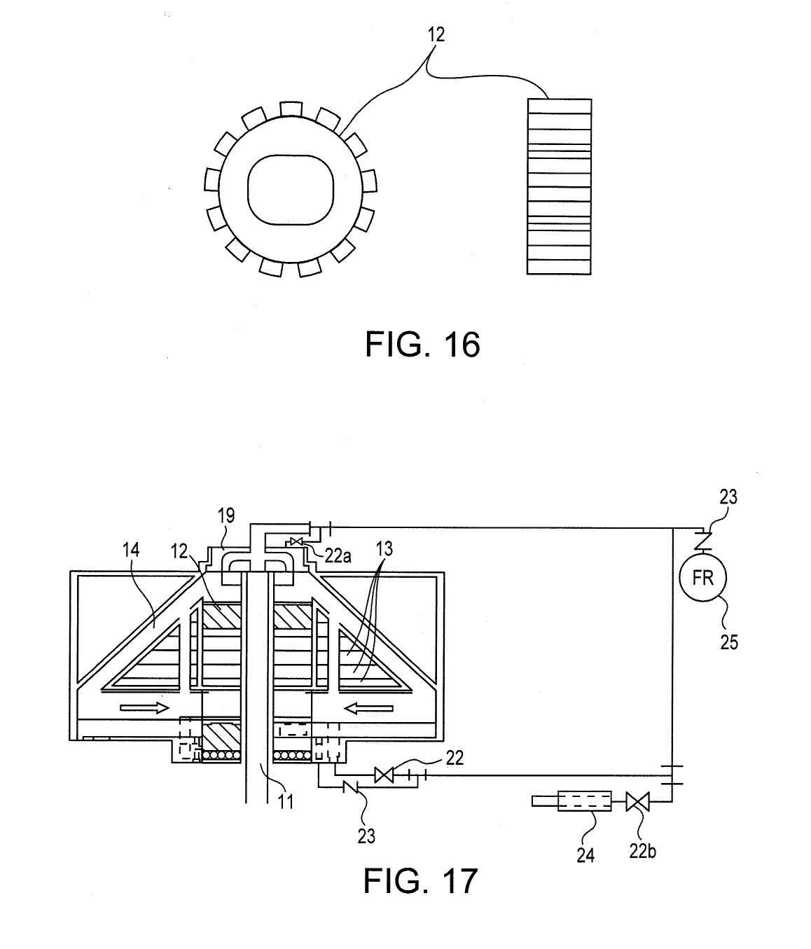

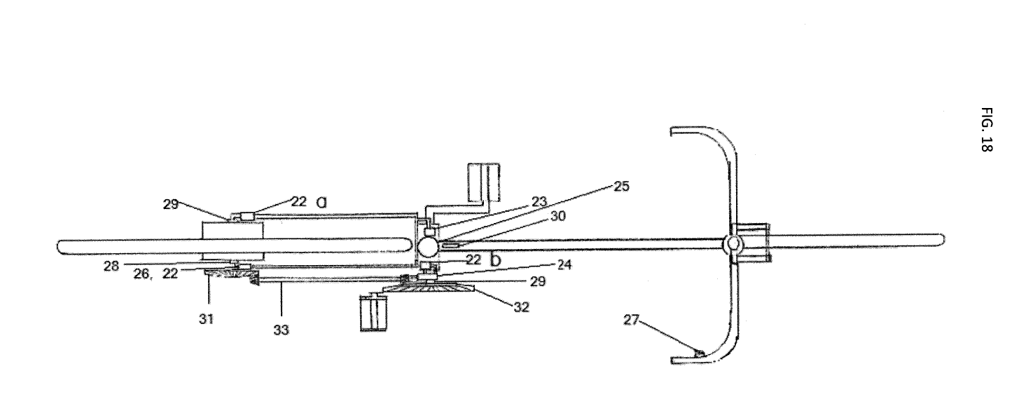

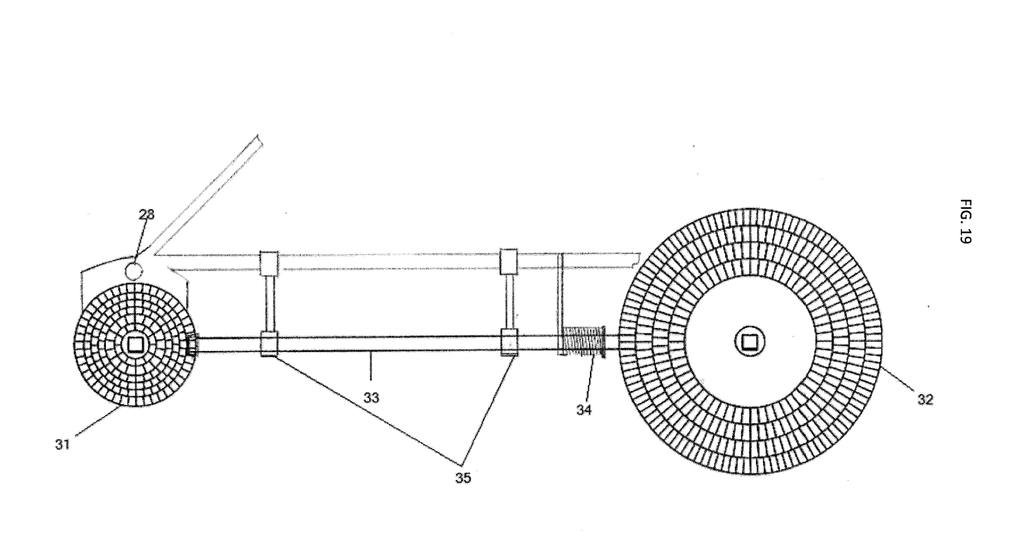

With reference to FIGS. 1-17, exemplary embodiments of the present invention are now discussed. In one aspect of the present invention, the transmission includes a housing (15) that includes a plurality of parts. The parts may include a single element, or two or more elements operatively connected together. The housing may be configured and dimensioned to have any dimensions desired by those skilled in the art. For instance, in one embodiment the housing (15) may be cylindrical. In embodiments where the housing (15) is cylindrical, the dimensions of the housing may be varied as desired. Modifying the dimensions of the housing (15) may provide the advantage of allowing the present invention to be used in combination with different wheeled or otherwise mobile vehicles or apparatus.

One way to describe the dimensions of the cylindrical housing is by its diameter. In one embodiment, the diameter of the cylindrical housing is preferably between about 1 inch and about 12 inches. More preferably, the diameter of the cylindrical housing is between about 3 inches and about 10 inches. Most preferably, the diameter of the cylindrical housing is between about 5″ and about 8″. In another embodiment, the diameter of the cylindrical housing is preferably about 5″ or greater. More preferably, the diameter of the cylindrical housing is about 10″ or greater. Most preferably, the diameter of the cylindrical housing is about 18″ or greater.

The cylindrical housing may comprise any material known to those skilled in the art. Examples of materials that may be used include metal, plastic, composites, nanotubes or other nanomaterials, or glass. The materials may include surfaces that induce or reduce friction. For instance, the materials may be scored or otherwise made rough in order to induce friction, or they may be coated with a friction reducing substance, such as Teflon, in order to reduce heat and/or wear and tear on parts.

Part or all of the housing may optionally conduct electricity. One advantage of allowing the housing to conduct electricity is that it may be used to transmit electrical signals between elements of the present invention. Alternately, an electronic memory, e.g., flash memory, Random Access Memory (RAM), Read-only Memory (ROM), and/or programmable memory, may be used in combination with the housing in order to store data regarding the operation of the housing. In embodiments that include a processor and/or memory, the housing (15) may include an interface that is operable to facilitate data transfer, such as a Universal Service Bus.

In one aspect, the internal parts preferably rotate in unison with the drive shaft. The centrifugal force created by the rotation of the impeller (14) pushes the fluid throughout the transmission. The impeller may be configured and dimensioned in any desirable manner known to those skilled in the art. For instance, the impeller may be radial, axial, or a specialty design, and may be open or closed. The shape and size of the impeller may depend on the type of impeller used, but is not intended to be limited to any particular size or shape.

The impeller may be operable to rotate at any desired speed. One way to describe the rotational speed of the impeller is by revolutions per minute (rpm). In one aspect, the impeller is preferably operable to rotate at between about 300 rpm and about 4000 rpm. More preferably, the impeller is operable to rotate at between about 1000 rpm and about 3500 rpm. Most preferably, the impeller is operable to rotate at between about 1500 rpm and about 2500 rpm. In another embodiment the impeller is preferably operable to rotate at about 500 rpm or greater. More preferably, the impeller is operable to rotate at about 2500 rpm or greater. Most preferably, the impeller is operable to rotate at about 4000 rpm or greater.

Any fluid may be used in combination with the present invention. The fluids that may be used in combination with the present invention include Newtonian and Non-Newtonian fluids. For instance, water, air, oil, hydraulic fluid, and polymers may be used. Other fluids having any desired viscosity may also be used.

The fluid pressure, according to one aspect of the present invention, may be used to change the gear ratio from low gear to high gear and vice versa. In one aspect, substantially all of the mechanism is positioned inside the housing unit (15) in the hub of the wheel. In other embodiments, however, a portion of the mechanism may be positioned externally to the housing unit (15). The mechanism preferably includes a plurality of moving parts that are set into motion by the drive shaft (11).

The drive shaft (11) may comprise a single element or multiple elements. For instance, the drive shaft (11) may comprise a telescoping member. For instance, the drive shaft (11) may comprise a solid element comprising two telescoping ends. Alternately, the drive shaft (11) may comprise a solid element that has only a single telescoping end. In other embodiments, the drive shaft (11) may comprise more than one solid element. Other elements, including wheels, levers, pulleys, gears, or other parts may also be included as desired according to a particular application. In addition, the drive shaft (11) may be formed using any material known to those skilled in the art, including metal, plastic, glass, composite, polymers, and/or nanotubes.

The drive shaft (11) first engages a primary gear (12) which moves linearly along the shaft (11) and engages with the series of gears (13) which have a range from a low to high speed of ratio. The primary gear (12) and the series of gears (13) may also be configured and dimensioned in any manner known to those skilled in the art. For instance, the linkages of the gears (12) and (13), e.g., the cogs or teeth, may be configured as desired. In one aspect, the gears may be internal or external. Any type of gears may be used including, but not limited to, spur gears, helical gears, double helical gears, bevel gears, crown gears, hypoid gears, worm gears, rack and pinion gears, sun and planet gears, non-circular gears, and harmonic drive gears.

A fully or partially encased impeller, (14) in which the series of gears (13) individually drives depending on the position of the primary drive gear (12) during operation, is preferably also the output or secondary drive shaft of the mechanism that extends to the outer portion of the housing unit. The impeller (14) preferably pumps the fluid into the discharge chamber (16) of the housing unit which distributes the fluid to both the primary gear chamber and the suction intake chamber.

The discharge chamber (16) may optionally be a separate element but is operatively connected to the impeller housing unit that is part of the second half of the pump housing. The second half of the pump housing also includes at least one, but preferably a plurality of suction return ports that are located on the outside area of the housing unit. The second half of the pump housing may also include an internal regulating chamber located between the axle and the suction return ports.

One aspect of the regulator utilizes a cup ring disc (12-a), a tension spring (12-b) and controlling pressure from the suction return chamber with the use of a valve, e.g., a needle valve to maintain regulated pressure in the primary gear chamber. The rotating disc (17) may be selectively positioned between the discharge chamber (16) and the lowest or first gear of the series of gears in the mechanism. The outer edge of the disc includes gearing which preferably meshes with the impellers (14) gearing causing the disc (17) to rotate in unison with the rest of the mechanism. The disc preferably includes flow ports in the lower diameter area of its face that allow flow to the suction area located inside the body of the series of gears (13).

The disc (17) also contains sliding vanes located at the smallest diameter area and protruding perpendicular from it. Used as gates in one embodiment, the sliding vanes rotate at the bottom of the discharge chamber (16) allowing flow into the primary gear chamber. With the disc rotating in unison with the rest of the mechanism, proper pressure flow may be released into each chamber. The suction intake chamber, which is selectively located in the opened area created through the face of the series of gears, allows fluid to flow through into the suction intake of the impeller. It is desirable for fluid flows into the suction chamber from the discharge chamber through the rotating disc, and from the primary gear chamber through flow ports located at the smallest diameter area of the series of gears. The flow port in the series of gears creates a balance of pressure between the two chambers, which ensures smooth internal operation of the mechanism.

One aspect of the mechanism utilizes an external bypass system for the other operations necessary for total functionality. The bypass utilizes the excess pressure created by the impeller to operate a piston cylinder (24) used to change the front bevel gear ratio setting. The bypass may have one or more connections on the transmission that are operatively connected together, e.g., using tubing. The high pressure discharge flow port (18-b) may be connected with flow ports to the discharge chamber through an unrestricted area of the suction return chamber section and next to the primary drive shaft and above the secondary bypass port.

Both low pressure discharge port and the high pressure discharge port are located in each of their own part of the ring manifold chamber of the housings end plate section. The low pressure suction return flow port (18-a) is preferably located in the center of the end cap (19), allowing fluid to flow in and around the primary drive shaft and up into the suction area of the impeller. The end cap may utilize one or more directional flow discs that distributes the fluid to the correct area of the mechanism.

The outer directional flow disc (19a), in one embodiment, is engaged by an internal piston, operatively connected to by a connecting arm, and actuated by pressure from a solenoid actuated N.C. two way valve (22-a) during high speed gear changing. The outer directional flow disc may be used to block the flow into the suction area of the impeller. The inner directional flow disc (19b) may be engaged in two ways, one by a spring clip (11-a) which engages the disc during reverse operation of the primary drive shaft during low speed operations and the second by pressure from a solenoid actuated two way valve (22-a) which may be activated by a switch on the bicycle handle bars.

The switch during high speed gear changing operations may activate two solenoid actuated two-way valves on the bypass (22; 22-a) and a solenoid actuated three way valves (22-b) which pressurize and relieve the piston cylinder (24) of the front sprocket. The switch may comprise a double pole double throw type for the two types of gear changing operations necessary, increasing and decreasing of the gear ratio of the transmission. The low pressure discharge bypass connected to the ring manifold of the end plate chamber section includes a check valve (23) that runs parallel to the solenoid actuated two way valve (22) of the high pressure discharge bypass that may be operatively connected to the high pressure discharge port. These two bypass lines tee together to utilize a single external bypass line.

The housing unit may optionally include an internal suction return located on the outside portion of the embodiment. It is desirable for the entrance to the suction return ports to be selectively positioned next to the discharge chambers exhaust port area next to the sliding vanes of the rotating disc. The area between the drive shaft and the entrance of the suction return ports may include a flow regulating valve. The flow regulating valve utilizes a cup ring (12-a), a resilient means (12-b), a pressure line, and needle valve (12-c) to regulate flow out of and pressure inside the primary gear chamber and into the internal and external suction returns or bypass systems.

The purge valve (28) may be positioned in the top of the discharge chamber extending out through the side of the chambers end plate section on the housing unit, relieves the mechanism of air trapped in the top of the system. The fluid reservoir (25) and check valve (26) included in and utilized by the mechanism are located at and tee into the suction return tubing between the three way valve and the suction port of the end cap. The R.P.M. sensor (29) contained in the mechanism is selectively positioned, one on the front bevel gear plate and one on the hub of the drive wheel. The sensor sends an electrical signal to a control or I.C. unit (30) that preferably triggers the solenoids to activate the valves to complete the automatic operations necessary.

### The Exemplary Method of the Present Invention

According to one aspect of the present invention, the mechanism, preferably driven by external force, rotates simultaneously to produce a smooth operation, and creates pressure in circulating hydraulic fluid, which is used to automatically change the gears of the transmission. According to this aspect, the impeller (14) creates pressure, which is diverted through the discharge chamber (16) into different chambers. Preferably, two separate chambers are used.

In this embodiment, the first chamber may include a high pressure chamber referred to as the primary gear chamber and a second chamber comprises a low pressure chamber referred to as the suction intake chamber. As rotation increases, the pressure increases in both chambers. To create a balance between the two chambers, pressure equalization flow ports are designed into the smaller circumference area of each of the series of gears (13) near the cogs. The amount of the flow through the ports may be determined by the pressure/R.P.M. ratio needed to create adequate gear change during the operation of the transmission. This may be set as desired by those skilled in the art. The pedal speed of the operator will be at a constant yet substantial rate for the person to maintain. The faster the operator pedals the sooner they will create a higher gear ratio of operation.

In one embodiment, the transmission housing may include two sections. The first section may include the impeller (14), a series of gears (13), a primary gear (12) and at least a portion of the drive shaft (11). It is desirable for the second section to include the discharge chamber (16), an internal suction return ports area, a regulator with cup ring disc (12-a), tension spring (12-B) and pressure line and needle valve (12-c) to maintain operating pressure in the primary gear chamber. Both sections preferably include an opening for the ends of the primary drive shaft (12), which is preferably cylindrical, the secondary or external drive shaft (14), and the end cap (19), which is located inside the secondary drive shaft. As will be appreciated by those skilled in the art, the housing is preferably filled with a fluid of suitable weight and viscosity to ensure proper operation of the mechanism. In other words, any fluid including water, oil, and the like may be used as desired.

According to this embodiment, the drive shaft (11) engages the primary drive gear (12), which engages one of the series of gears (13), which engages the impeller (14) such that all of these elements rotate in unison. Thus, as the drive shaft (11) rotates, the impeller (14) will also rotate. The rotation of the impeller (14) will circulate the fluid through the housing (15) into the discharge chamber (16).

The rotating disc (17) located next to the discharge chamber (16) includes flow ports and sliding vanes. The disc (17) preferably engages and rotates in unison with the impeller (14). The rotation of the disc causes the ports to open and close in sequence creating simultaneous flow and flow restriction between the two chambers. Thus, as the fluid is pumped into the discharge chamber (16), it will be distributed into two chambers, the primary gear chamber and the suction intake chamber.

The primary gear chamber, according to one aspect, receives the greater amount of pressure to move the primary drive gear (12) along the drive shaft (11) to engage each of the series of gears (13), and the suction intake chamber located inside the series of gears (13) receives the exhaust pressure of the impellers discharge chamber (16). It is desirable for the pressure created by the impeller (14) pushes the primary drive gear (12) linearly along the drive shaft's (11) worm gearing design.

In one aspect of the present invention, the primary drive gear (12) has opposing twist on the internal and external surfaces to mesh with the drive shaft (11) and the series of gears (13). The total degree of twist of the drive shaft and the external surface of the primary gear is preferably minimal enough to turn the impeller before the torque and the fluid pressure pushes the primary drive gear (12) along the drive shaft (11). Those skilled in the art will understand that the primary drive gear (12) may be positioned along the drive shaft (11) according to the rotation speed of the impeller (14) and resistance torque on the external secondary drive shaft, which are inversely proportional to each other.

The suction intake chamber, optionally located in the lower diameter area of the series of gears (13), is an open area in the face of each gear. Flow is preferably allowed up through the openings in the top gearing area of the gears to the suction port of the impeller, which may be located at the inside of smaller diameter area or the narrower part of the cone shaped impeller (14) and into and between the fins of the impeller. The rotation of the impeller (14) preferably pulls the fluid into the impeller blades and out of the impeller to the discharge chamber (16).

According to one aspect, the impeller (14) contains a suction area located on both sides and the bottom to eliminate axial thrust. The reverse flow port area may be selectively located in the external drive shaft at the base of the inverted impeller area immediately before the inverted impeller area begins, and allows flow to the low pressure side of the primary gear chamber. The reverse rotation of the impeller (14) creates reversal of flow through the reverse flow port into the primary gear chamber (12) creating pressure against the gear to assist in the lowering of the gear ratio of the device during reverse operation.

In one embodiment, to allow fluid to flow evenly to and out of a circular manifold area inside the cap, the end cap (19) may include a suction flow port connection in the center. The fluid flowing out of the cap may be diverted to the area necessary for the correct operation by two directional flow discs, an inner directional flow disc (19-b) and an outer directional flow disc (19-a), although more than two directional flow discs may be used. The discs preferably work in unison with each other during operation of the mechanism.

For instance, during start up of the transmission, the flow discs may be positioned in the forward or default position. Positioning in this manner allows for the bypass suction flow to enter the base of the impeller so as to balance the operating pressures of the primary gear chamber. The bypass, which is preferably connected between the discharge or high pressure side and the low pressure or suction side, allows fluid to exit the primary gear chamber through a flow port located next to the primary drive shaft in the discharge chambers housing section and enter a suction flow port in the center of the cap on the opposite side of the transmission.

Though it may not be necessary, the directional flow discs will be activated during repositioning of the primary gear. During low speed down shifting, only the inner directional flow disc will be reversed to the secondary flow directional position to allow fluid to flow from the impeller and suction bypass to the primary gear chamber (reverse operation of the primary drive shaft is necessary for this operation). This pressure repositions the primary gear to the first in the series of gears. When operation resumes, a resilient means or tension spring repositions the inner directional flow disc to its forward or default position.

During high speed repositioning of the primary gear, for example, both directional flow discs may be activated by a solenoid actuated valve which allows pressure to an internal piston cylinder (located in the end cap (19)) to the reverse position allowing the fluid to enter the primary gear chamber from the suction bypass while preventing flow into the suction area of the impeller. The pressure utilized by the discharge chambers bypass tubing flows to the three way solenoid valve (22-b). The valve may utilize a relief port that may be operatively connected to the suction side of the transmission. The low pressure bypass port preferably maintains pressure and flow in the mechanism. The high pressure solenoid valve ports are activated or opened (N.C.) when the electrical switch (27) is activated, either manually or automatically. When the electrical switch activates all three solenoids located on the valves, the total gear ratio on the front beveled gear plate (32) and the rear beveled gear plate (31) is changed.

When the device rotates in the reverse direction, in one embodiment, the fluid is pushed down through flow ports of the impeller at the apex of the exterior drive shaft and into the low pressure side of the primary gear chamber. A flow port selectively positioned in the face of the primary gear prevents suction lock inside the chamber. It is desirable for the reversal of rotation to cause the pressure to increase on the low side of the primary drive gear (12) and assisting in the repositioning of the said primary gear (12) to a lower gear ratio.

According to one embodiment of the present invention, the fluid bypass system and pressure supply tubing for the piston cylinder operates the gear changing mechanism. Two discharge ports may be located near the drive shaft area of the discharge chamber (16) side of the transmission. A suction return may be located in the center of the cap (19) on the suction side of the transmission. The discharge and the suction ports may be operatively connected, for example, using tubing or another conveyance system known to those skilled in the art.

In one aspect, the bypass tubing may optionally utilize a three way solenoid valve (22-b). A solenoid actuated two-way valve (22) may be used to discharge the operating pressure from the discharge chamber and primary gear chamber (16) pressurizing the piston cylinders and the suction side of the primary gear. The three way valve (22-b) may utilize the relief port when needed to decrease the gearing ratio of the front beveled gear plate (32), and the rear beveled gear plate (31) and the two way valve (22) resets the primary gear to the first in the series of gears. The extra pressure and fluid flow from the secondary bypass port circulates through the bypass tube to the suction return port to create balance in the transmission.

One embodiment of the present invention may also include a secondary bypass that includes a check valve (23) that may run parallel to the solenoid actuated two-way valve of the high pressure discharge and tee together before teeing into the three way solenoid valves (22-b) intake port and piston cylinder's return port. The check valve prevents pressure from entering into the suction return area of the pump when the normally closed two-way valve's solenoid is activated by a normally open switch located on the unit. The manually operated switch located on the handle bars of the bicycle also activates a normally closed solenoid activated three-way valve (22-b) to allow pressure to an external positioning piston cylinder (24) which will reposition the beveled gears on each end of the external drive shaft (33) engaged to the front beveled gear plate (32) and the rear beveled gear plate (31). The pressure created by the impeller and stored in the master cylinder might also be utilized by other accessories such as a hydraulic braking system.

Although the present invention has been described with reference to particular embodiments, it will be understood to those skilled in the art that the invention is capable of a variety of alternative embodiments within the spirit of the appended claims.

1. A method for automatically switching transmission gears, comprising:
creating pressure based on the rotation of a drive shaft;
discharging the pressure through a discharge chamber into two separate chambers;
moving a primary drive gear along a drive shaft to engage a series of gears; and
automatically moving the primary drive gear linearly along the drive shaft based on an increase in the created pressure.
